(19) United States
(12) Patent Application Publication
(10) Pub. No.: US 2009/0251405 A1
(43) Pub. Date: Oct. 8, 2009

(54) COLOUR REFLECTIVE DISPLAY DEVICES

(75) Inventors: Sander Jurgen Roosendaal, Eindhoven (NL); Martinus Hermanus Wilhelmus Maria Van Delden, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/438,741

(22) PCT Filed: Aug. 28, 2007
(86) PCT No.: PCT/IB2007/053451

§ 371 Date: Feb. 25, 2009

(30) Foreign Application Priority Data
Aug. 31, 2006 (EP) 06119934.5

(51) Int. Cl. G09G 3/34

(52) U.S. Cl. 345/107

(57) ABSTRACT

A colour reflective display device uses two colour absorbing components (40,42), and the quantity of the two colour absorbing components within the pixel aperture can be independently controlled. The first colour absorbing component has a colour (C) at a point lying substantially between the green and blue regions of an (x,y) chromaticity diagram, and the second colour absorbing component has a colour (O) at a point lying substantially between the green and red regions of an (x,y) chromaticity diagram. The invention provides a colour active light shutter layer with only two colour components. One is selected to be near cyan and the other is selected to be near orange, and these together enable a range of colours to be produced which enables good quality colour images to be produced.

This invention relates to colour display devices, in particular colour reflective display devices.

There are many types of monochrome reflective displays, for example reflective LCDs, electrophoretic displays, electrowetting displays and electrochromic displays.

LCD displays, in-plane electrophoretic displays and electrowetting displays are based on a transmissive light shutter which is switched between a transparent state and an absorbing state, which is placed in front of a reflector.

There are several ways of using the above-mentioned technologies to make a reflective colour display. For LCD technology, the conventional approach is to divide each pixel into three sub-pixels and cover these with a red, green and blue colour filter. The advantage of this approach is that the shutter layer does not have to be altered. The disadvantage is a loss of brightness and aperture. Each sub-pixel transmits roughly ⅓ of the visible light, and thus the maximum white light intensity is ⅓ of that of the monochrome display.

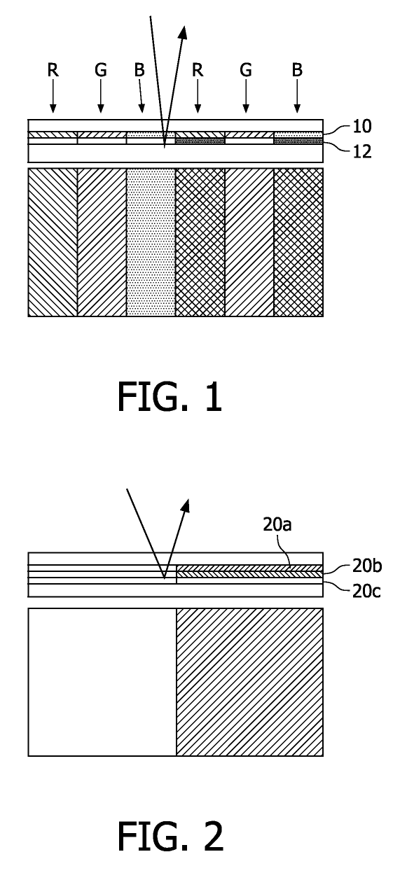

FIG. 1 shows how colour filters are used to provide a colour reflective display. The top part of FIG. 1 shows the display in side view, and illustrates the colour filter layer 10 and the light absorbing (display) layer 12. The bottom part of FIG. 1 shows two adjacent pixels in top view, each comprising three sub-pixels. The left group of three sub-pixels is for displaying a white pixel and the absorbing layer 12 allows light to pass through all three sub-pixels, giving full brightness red, green and blue (RGB) outputs.

The right group of three sub-pixels is for displaying a green pixel and the absorbing layer 12 blocks light to for the red and blue sub-pixels, giving a bright green output only.

An advantage of both electrowetting and in-plane electrophoretic reflective displays is their use of a subtractive colour scheme.

This enables a colour image to be produced using the approach explained with reference to FIG. 2.

The display consists of three layers 20a,20b,20c which can be switched between transparent and cyan, magenta, and yellow, respectively. The brightness of the colour display is now 100% of the monochrome version (ignoring aperture losses due to stacking), as the full pixel area can be made transparent.

The left pixel is white, whereas the absorbing layers 20a,20b are controlled in the right pixel, to give a desired pixel output colour.

This invention is of particular interest to colour reflective displays in which multiple reflective particle species are provided, and is therefore of particular interest for electrophoretic display devices. In-plane switching electrophoretic display devices can be adapted for this type of operation.

In a subtractive colour scheme, a black level can be made by absorbing red, green and blue parts of the backlight spectrum by moving cyan, magenta and yellow electrophoretic particles (respectively) in a transparent fluid into the light path. White is made by moving all of these coloured particles out of the light path into a so-called “container”.

This approach also enables a backlight to be used. It does, however, require three different types of particle which can be moved independently between the container and the pixel aperture.

An advantage of the in-plane electrophoretic display (compared to the electrowetting display), is the possibility to control two types of pigment in a single layer, for example by different mobilities, different electrical charges, or a different transport mechanism, or a combination of these.

For example by having particles which move with different speeds, these speed differences can be used to devise a control scheme which enables selected particles to be moved to the pixel aperture. Such an approach is described in WO 2004/088409 and WO 04/066023. The use of different frequency responses of the particles has also been proposed as a way of providing independent driving of each colour particle.

This can be used to reduce the number of layers in FIG. 2 from three to two. Furthermore, an additional black pigment can be controlled in the second layer, yielding a 4 colour system (CMYK) comparable to that of modern printers.

The use of fewer layers is desirable, as it is a technological challenge to manufacture a display containing three layers of controllable pigments as shown in FIG. 2.

One way of making a single layer system is shown in FIG. 1, but this has the disadvantage of low brightness.

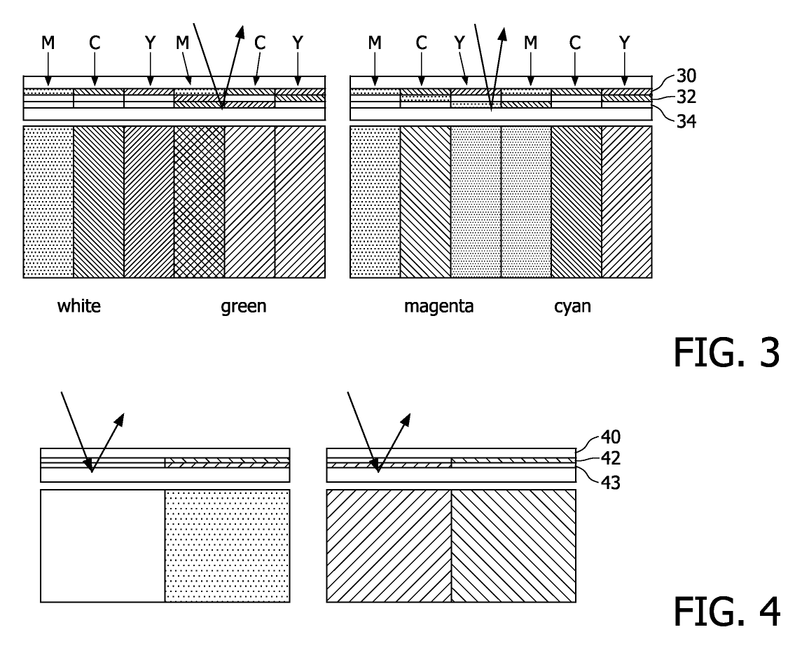

An alternative way of making a colour system which does not require three active light shutter layer layers is shown in FIG. 3. Each pixel has a colour filter layer, with cyan, magenta and yellow colour filter dyes (C,M,Y), and with each pixel having the same colour filter pattern.

Within each pixel, there is a fixed colour filter in one of the three subtractive primaries, and the density of the two other subtractive primaries can be controlled, by two active light shutter layers 32,34.

The two active light shutter layers 32,34 thus have different particle colours at different pixel positions. Each sub-pixel thus has a colour filter of one subtractive primary and colour particles of the other two subtractive primaries.

The pixel furthest left (again a group of three sub-pixels) is for displaying white, and no particles are in view. The light output of the pixel corresponds to the colour filters, namely, magenta, cyan and yellow sub-pixels.

The second pixel is for displaying green. As the magenta filter absorbs green, the cyan and yellow particles are used to make the first sub-pixel black. The next two sub-pixels display green, by arranging the colour filter and particle layer together to comprise cyan and yellow.

The next pixel is for displaying magenta. This is the combination of red and blue. The first sub-pixel has no particles so that the magenta colour filter gives a magenta output, and the next two sub pixels display red and blue respectively.

The last pixel is for displaying cyan. This is the combination of blue and green. The middle sub-pixel has no particles so that the cyan colour filter gives a cyan output, and the first and third sub pixels display blue and green respectively.

This technology has a bright state reflectivity of 67% (two thirds) compared to the monochrome display. Of course, for an implementation using an in-plane electrophoretic display, the two particles required by each sub-pixel can be controlled inside a single layer, instead of the two layer solution shown in FIG. 3.

A disadvantage of this solution is the fact that both the colour filter and the pixel particles (dyes) need to be patterned, in contrast with the solutions of FIGS. 1 and 2, where the same dye or combination of dyes is present throughout the entire layer of FIG. 1. Furthermore, a colour filter is necessary, unlike the approach of FIG. 2.

It can be seen from the discussion above that there are difficulties in providing a colour reflective display which can easily be manufactured. Instead, a comprise is reached between the need for accurate patterning of layers, and the need for a large number of different layers.

According to the invention, there is provided a colour reflective display device, comprising a plurality of display pixels, wherein each pixel comprises two colour absorbing components, wherein the quantity of the two colour absorbing components within the pixel aperture can be independently controlled,

wherein the first colour absorbing component has a colour at a point lying substantially between the green and blue regions of an (x,y) chromaticity diagram,

wherein the second colour absorbing component has a colour at a point lying substantially between the green and red regions of an (x,y) chromaticity diagram.

The invention provides a colour active light shutter layer with only two colour components. One is selected to be near cyan and the other is selected to be near orange, and these together enable a range of colours to be produced which enables good quality colour images to be produced. The two colour components are positioned with a chromaticity diagram such that a line connecting them divides the RGB colour triangle into an upper part having the green apex and a lower part having the red and blue apexes. Each pixel has the same colour components, so that complex patterning of the display pixel layer is not required. However, a colour output can be required with a range of colours with no colour filtering.

The line connecting the colour points of the first and second absorbing components, in an (x,y) chromaticity diagram, preferably substantially passes through the point representing white. Thus, the range of colours can provide a smooth transition from white to the two extreme colour values.

The first and second absorbing components, when combined, may allow transmission of green light, grey light or purple/magenta light.

The device preferably further comprises a coloured reflector. This enables the colour output to shifted towards a colour which cannot be obtained from the pixel design with a white reflector.

The coloured reflector preferably has an attenuation of white light of less than 20% and preferably less than 15%.

The coloured reflector may be magenta (or light magenta, i.e. purple), in particular for first and second absorbing components, which when combined, allow transmission of green light. In this way, when the particles block the pixel aperture, the combined effect of the particles and the reflector is to provide an output approaching black (as the green light transmitted is not reflected by the magenta reflector).

The coloured reflector may be light green, in particular for first and second absorbing components, which when combined, allow transmission of purple or magenta light. In this way, when the particles block the pixel aperture, the combined effect of the particles and the reflector is to provide an output again approaching black (as the magenta light transmitted is not reflected by the green reflector).

A white reflector may be used, particularly for first and second absorbing components, which when combined, allow transmission of grey light.

The reflector may be the same colour for all pixels, but it may also be patterned so that different pixels are able to provide the missing colour components, for example green or magenta.

The device preferably comprises an in-plane switching electrophoretic display device, for example with each pixel comprising particles suspended in a fluid, with a reservoir for housing the particles outside the pixel aperture.

The invention also provides a method of driving a display device, comprising moving coloured light absorbing particles into the optical aperture of each pixel to control the light absorbed and reflected by the pixel and thereby control the reflected colour output, wherein each pixel comprises two colour absorbing components, with the quantity of the two colour absorbing components within the pixel aperture being independently controlled, wherein the first colour absorbing component has a colour at a point substantially along the line connecting the green and blue regions of an (x,y) chromaticity diagram, and wherein the second colour absorbing component has a colour at a point substantially along the line connecting the green and red regions of an (x,y) chromaticity diagram.

The method may further comprise converting a desired output colour and intensity into an output colour and intensity which can be produced as a pixel output.

This conversion can comprise shifting the desired output colour on an (x,y) chromaticity diagram onto a path between the points of the first and second colour absorbing components which can be followed by selecting different quantities of the first and second colour absorbing components.

Examples of the invention will now be described in detail with reference to the accompanying drawings, in which:

FIG. 1 shows a first known use of colour filters to generate a colour reflective display;

FIG. 2 shows a second known reflective colour display using multiple active light shutter layers;

FIG. 3 shows a third known reflective colour display using one or two active light shutter layers in combination with a patterned colour filter;

FIG. 4 shows a first example of display system of the invention;

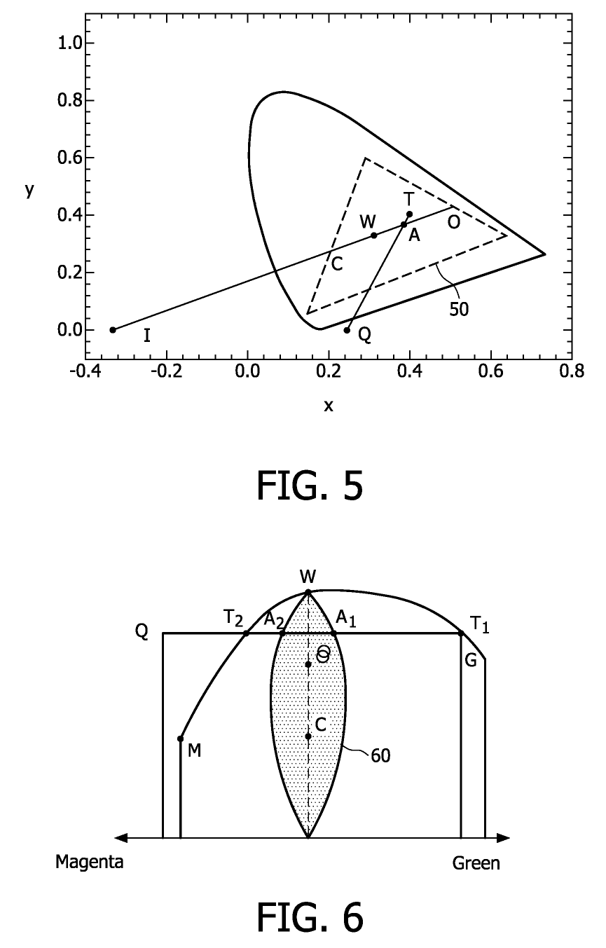

FIG. 5 is a chromaticity diagram to explain the invention;

FIG. 6 is a diagram to explain a colour mapping method of the invention;

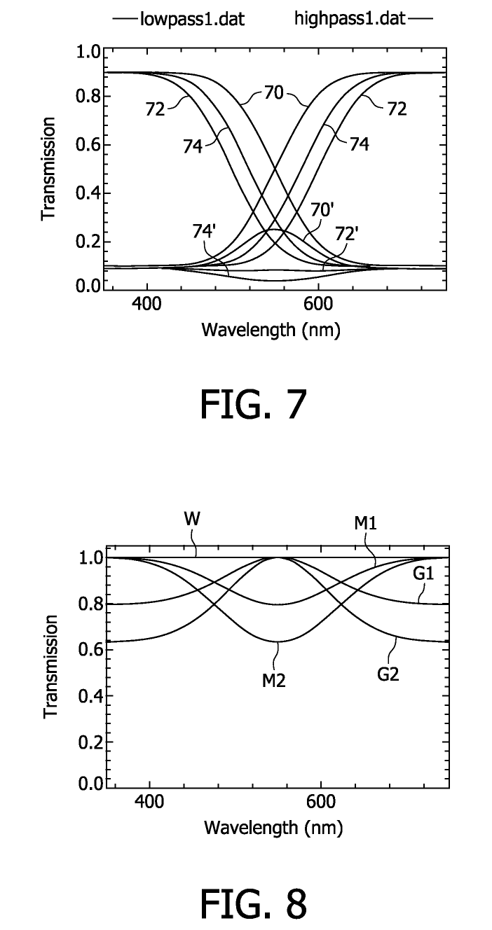

FIG. 7 shows the frequency response of various colour dye pairs which can be used in the system of the invention;

FIG. 8 shows the frequency response of various colour reflectors which can be used in the system of the invention;

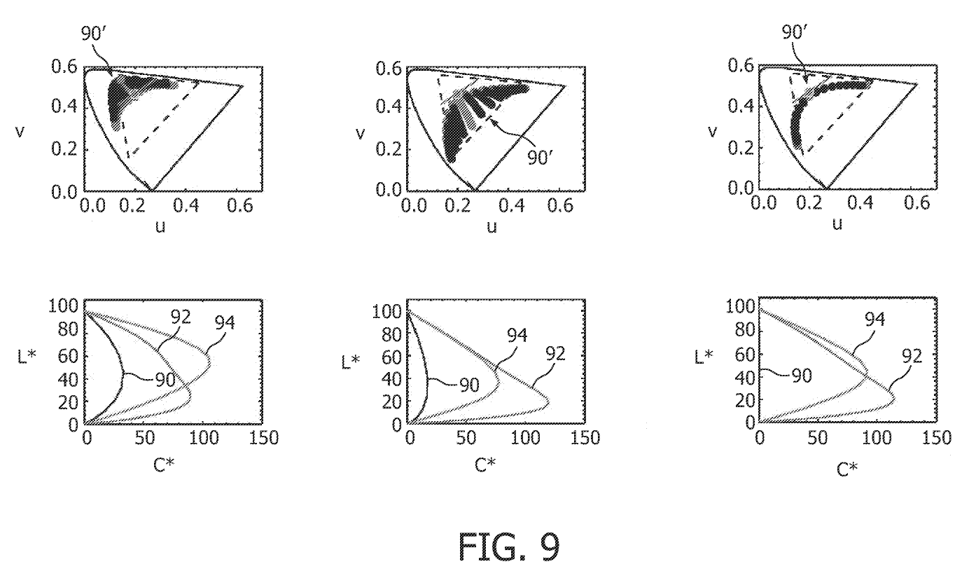

FIG. 9 shows the colour response of a first example of display system of the invention;

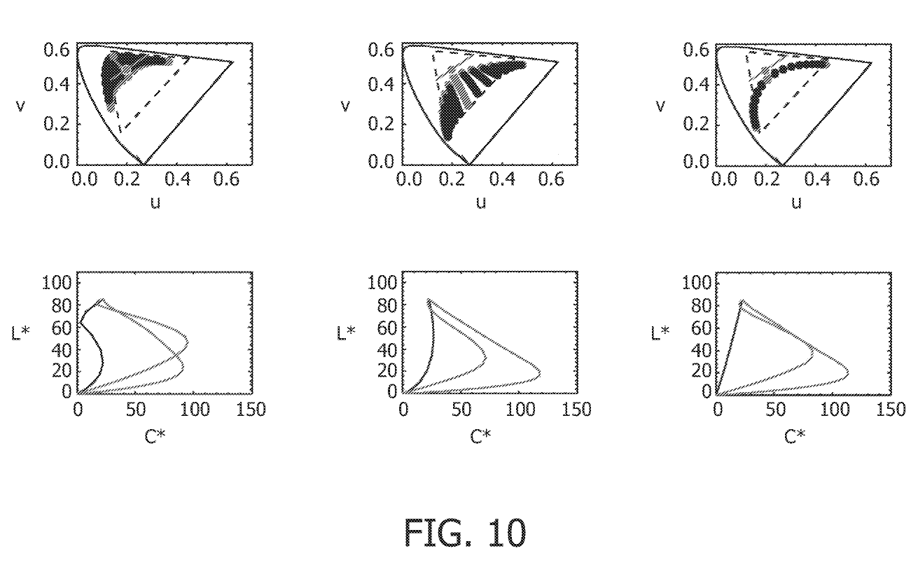

FIG. 10 shows the colour response of a second example of display system of the invention;

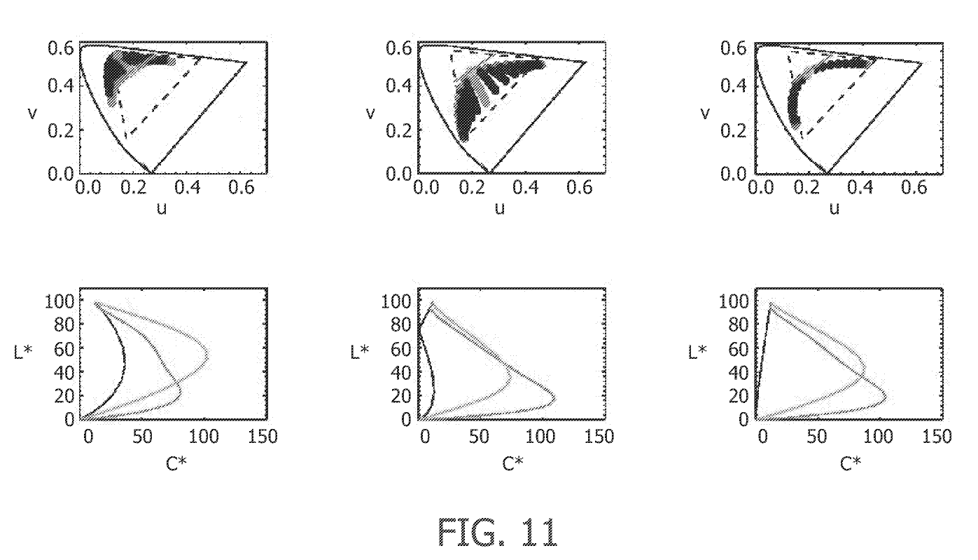

FIG. 11 shows the colour response of a third example of display system of the invention; and

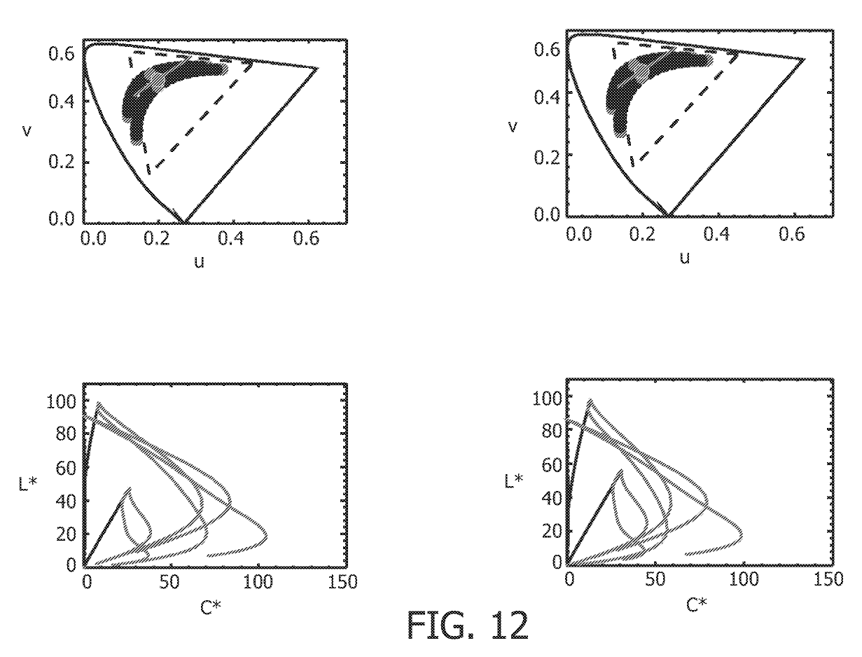

FIG. 12 shows the colour response of a fourth example of display system of the invention.

The same references are used in different Figures to denote the same layers or components, and description is not repeated.

The invention provides a colour reflective display device, in which only two colour absorbing components are used by each pixel, and the same colour absorbing components are used by all pixels, so that the active light shutter layer does not need to be defined differently for different pixels (i.e. patterned). The first colour absorbing component has a colour at a point lying substantially between the green and blue regions of an (x,y) chromaticity diagram (for example cyan), and the second colour absorbing component has a colour at a point lying substantially between the green and red regions of an (x,y) chromaticity diagram (for example orange).

FIG. 4 illustrates the general concept of the idea, and shows four different pixel settings as pixels A to D.

The pixels have two particle species, and for simplicity these are shown as separate active light shutter layers 40,42, whereas they may in practice be in a single layer. One particle species is orange (the top layer 40) and the other is cyan (the bottom layer 42). No patterned colour filter is required. Indeed, no colour filter is needed at all, but one may be used to shift the overall colour spectrum as will be explained below. Layer 43 can be a coloured reflector for this purpose.

The pixel can be loaded with varying concentrations of orange and cyan dye, and in this way the luminance can be varied for each point in a colour diagram on a line between orange and grey.

Pixel A has no particle species, so that a white background is viewed. Pixel B blocks cyan and orange light and the particle species are such that when combined they allow transmission of grey light, so that the resulting pixel colour is grey. As will be explained below, the combined effect of the two dyes can be selected to give a desired colour.

Pixel C shows that the cyan dye is used to transmit cyan so that a cyan pixel can be displayed, and Pixel D shows that the orange dye transmits orange, so that an orange pixel can be displayed. Other colours can be made by combining the particle species in different combinations.

FIG. 5 shows an x-y colour chromaticity diagram. This displays the “pure” colour in the absence of luminance (brightness) information, which must separately be defined (the Y value) for a colour to be fully defined. The dashed line 50 indicates the sRGB colour triangle, with the blue region at the bottom left triangle apex, the green region at the top triangle apex and the red region at the right triangle apex. Colour points within this triangle 50 are achievable with conventional colour filter displays. Also, the conventional CMY(K) dyes are limited to points within the dashed triangle.

The points C (cyan) and O (orange) depict the colour points of the two dyes used in the system of the invention, and the point W is white (at approximately (0.3,0.3). The line CWO indicates the range of colours that can be made with the two dyes.

One way to process an image to map a desired colour to the line CWO which can be output will now be explained.

A target colour T (x_{T},y_{T},Y_{T}) which is shown in FIG. 5 is to be made. A ratio of cyan and orange dyes in the pixel is chosen such that the actual colour A (x_{A},y_{A},Y_{T}) is obtained, which lies on the intersection of a line QT and the line CWO. The point Q is selected with y=0 and so is defined by a single value x_{Q}. In FIG. 5, a point I is shown which is an extrapolation of the lines CWO to the point where y=0. Thus, the point I essentially defines the values of C and O as these are constrained to lie on the line IW (as W is a fixed point), and the point I can be defined by a single value x_{I}. The luminance value Y is conserved.

In this example x_{I}=−0.333 and x_{Q}=0.245.

Thus, the target colour is shifted along a line TQ towards a predetermined point Q in the (x,y) chromaticity diagram until it reaches the path CWO between the dyes colours, and the point Q is in the vicinity of blue.

If the colour conversion method is considered in three dimensions, with the Y luminance value as the third dimension, it will be appreciated that some target colours cannot be generated because the luminance is too high. In this case, the pure colour is shifted to the line CWO and the luminance is capped.

However, FIG. 5 represents an idealised diagram, and the CWO plane may be a curve in the (x,y) plane instead of a straight line. Furthermore, for some combinations of dyes the gamut plane is actually a complex three-dimensional shape, for example curved in the green direction. As will be described below, a coloured reflector can be used (which may also be patterned) and in this case the achievable gamut is actually a volume and not a plane. This enables colours on opposite sides of the CWO line to be represented differently, for example green (at the top of the colour triangle) and purple (at the bottom of the colour triangle).

This concept is shown in FIG. 6, which shows a cross-section of such a volume 60 in the magenta-green directions. Thus, all points are projected on a plane perpendicular to the orange-white-cyan plane. Two target colours T₁ and T₂ are indicated. These are bright green and bright purple of the same luminance.

As shown T₁ is mapped to a point A₁ on the green side of the gamut volume and T₂ is mapped to a point A₂ on the magenta side of the gamut volume.

There are different solutions to scale the points on the line T₁ to T₂ to the line A₁ to A₂. One option is to clip all colours outside the volume indicated in grey to the points A₁ and A₂. Another possibility is to (linearly or non-linearly) scale the points on the line T₁ to T₂ to the line A₁ to A₂. Additionally, some scaling, mapping, and/or clipping is possible in the luminance direction.

The point I in FIG. 5 depends on the cyan and orange dyes used. Furthermore, the line connecting C and O does not necessarily pass through the point W. The point Q used for the shifting operation can be freely chosen.

As mentioned above, the luminance value Y can be clipped to an achievable output luminance, but other ways of providing the luminance correction are possible, for example:

Luminance scaling (linear or non-linear) of the entire picture such that all values are below the line CWO

Conversion to the point selected based on the proximity to the line from (x_{Q},0,Y_{T}) (i.e. colour of point Q but with the target luminance Y) to (x_{T},y_{T},Y_{T}) (i.e. the target colour and luminance) and the line CWO.

Addition of black (subtraction of white), i.e. a transfer in the direction towards the point K=(x_{W},y_{W},0).

The system of the invention essentially has two dimensional colour control, and accordingly it cannot reproduce the full range of colours in the colour triangle. As will be apparent from the above, the system is not able to produce rich green or magenta colours as these lie furthest from the line CWO.

One way to improve the image quality is therefore to provide a coloured reflector, to shift the colour output towards green or magenta (at the expense of no longer being able to generate a pure white.

The use of a coloured reflector does, however, improve the black performance, as the reflector colour can be chosen with regard to the combined effect of the two dyes to improve the quality of an output intended to be black.

FIGS. 7 and 8 show example combinations of dyes and reflectors that can be used. The dyes used are essentially high wavelength pass (‘orange’) and low wavelength pass (‘cyan’) dyes.

FIG. 7 shows three pairs of typical high pass and low pass filters used.

Lines 70 show a pair of dyes yielding green when combined. Lines 72 show a pair of dyes yielding grey/black when combined. Lines 74 show a pair of dyes yielding purple/magenta when combined.

The plots 70′, 72′ and 74′ show the transmission when the dyes 70, 72, 74 respectively are combined. For example, the curve 70′ has a high transmission region around 550 nm (green), because both curves 70 transmit a substantial amount of green light. The curve 70′ is not colour neutral. In the case of the dyes 74, the combined effect is the transmission of dark magenta.

The reflectors (or colour filters) used are purple (response 70′), light green (response 72′) and white (response 74′).

FIG. 8 shows five examples of reflector to be combined with the dyes of FIG. 7. The responses are shown for two purple reflectors (light magenta) M1 and M2, white W and two light green reflectors G1 and G2.

The reflectors are chosen to have non-saturated (i.e. light) colours so that a high brightness is retained, and thereby limit the effect on the white performance of the display. Increasing the concentration of any dye will decrease the transmission for all wavelengths, thus putting a limit on the saturation of the colours that can be made.

FIG. 9 shows the results of calculations of the obtainable colour gamut for the three combinations of dye pairs, with a white reflector.

The top part of the FIG. 9 shows the colour gamut in the u-v colour space. This is analogous to the xy colour space, and defines the pure colour with the luminance defined separately (luminance Y), but correlate the chromatic values to human visual response in a more linear fashion.

The beams shown in the Figure represent the colour obtained for different luminance values, so that the top Figure are expressing three dimensional information.

The bottom part of FIG. 9 shows the lightness L* as a function of the chroma C*. L* is a measure of perceived brightness, and its definition is such that it is approximately linear in the perception domain. C* is a measure of colourfulness or chroma, and also the definition of C* is such that it is approximately linear in the perception domain.

The left pair of plots in FIG. 9 is for a pair of dies yielding green when combined. The range of colours which can be produced essentially extends to the side of the line CWO towards the green corner of the colour triangle. As the luminance is reduced, by introducing the two dies, the colour point shifts towards green.

The middle pair of plots in FIG. 9 is for a pair of dies yielding magenta/purple when combined. The range of colours which can be produced essentially extends to the side of the line CWO towards the lower red-blue part the colour triangle. Again, as the luminance is reduced, by introducing the two dies, the colour point shifts towards magenta.

The right pair of plots in FIG. 9 is for a pair of dies yielding grey/black when combined. The range of colours which can be produced essentially defines a curved plot extending from blue to white to red, but the brightness for each of the colours along this plot can be controlled.

In the bottom Chroma-Lightness plot, the line 90 shows the curve for equal concentrations of orange and cyan dye, and these correspond to the regions 90′ in the uv plots.

The lines 92 indicate the behaviour if only the cyan concentration is varied and the lines 94 show the behaviour if only the orange concentration is varied.

For the dye combinations of FIG. 9, with a white reflector, the maximum obtainable lightness is 100%. However, neutral greys are only obtainable for the neutral grey dye combination.

The responses of FIG. 9 can be varied by using colour reflectors (or white reflectors in combination with a colour filter).

A magenta colour filter shifts the colour range towards the red-blue side of the colour triangle, as shown in the top part of FIG. 10, but this shifts the colour of the bright output so that it has an increased chorma C* as shown in the bottom part of FIG. 10.

When the purple reflector is used with dyes which combine to give a green colour, there is however one neutral grey level, and this can be seen in the left lower plot at L*=60. This combination of coloured reflector and dyes enables both light magenta and greenish colours to be achievable.

FIG. 11 shows the plot for a light green reflector. The colour filter shifts the colour range towards the green apex, as shown in the top part of FIG. 11, but this again shifts the colour of the bright output so that it has an increased chorma C* as shown in the bottom part of FIG. 11.

When the green reflector is used with dyes which combine to give a magenta/purple colour, there is again one neutral grey level, and this can be seen in the middle lower plot at L*=80.

The invention provides a bright display output and enables a wide range of colours to be obtained from two colour selective particle species.

One limitation of the system of the invention is that a good quality magenta colour is not possible (unless a deep magenta reflector is used which would mean that no colour approaching white would be possible). However, by increasing the resolution in one direction (preferably the column direction so that the update speed is not increased), magenta could be made by placing a red and a blue pixel next to each other.

It is also apparent from the analysis above, that a good quality green and good neutral greys are not compatible. Good natural greys requires the dyes which combine to form grey, whereas good green requires the dyes that combine to form green.

However, a combination of good neutral greys and reasonable greens can be made by patterning the reflector or using a colour filter, in combination with the grey dye pair. In this way some pixels have particularly good green response (those associated with the green reflector), and others have particularly good grey response (those associated with the white reflector).

This enables the colour gamut to be extended by only changing a passive component, but without changing the active light shutter layer itself, which can remain with the same dye pair for all pixels.

Of course, it is also possible to use different dye pairs in different pixels, but this then requires a patterned active light shutter layer).

The left part of FIG. 12 shows the colour and chroma plots for a display where 20% of the area is a light green and the rest is white, in combination with a neutral (i.e. combining to provide grey transmission) cyan-orange dye combination. The right part of FIG. 12 shows the colour and chroma plots for a display where 30% of the area is a light green and the rest is white, in combination with a neutral cyan-orange dye combination.

The ratio (20% or 30%) is applied to each pixel, so that each pixel has sub-pixel areas of white and green, and in this way each pixel can be controlled to use the grey response of the pixel or the green response of the pixel.

The colour plots show that each pixel effectively has a possible output colour which combines the two individual responses. The chroma plots show three situations: (i) both sub-pixels at the same grey level, (ii) the green sub-pixels switched to black and (iii) the white sub-pixels switched to black. The range of chroma curves show that this extends significantly the range of colour purity and brightness which can be produced.

The use of a coloured reflector only adds a single patterning requirement and does not complicate the active light shutter layer design.

The system does not reproduce images perfectly, and clearly there is a sacrifice in the accuracy of the image reproduction. However, the viewer will not have the original image as a comparison, and the image quality can therefore be perceived as very high. As one typical application is signage, the image quality is more than acceptable.

Furthermore, the image to be displayed can be designed taking into account the capabilities of the display system.

Electrophoretic display systems can form the basis of a variety of applications where information may be displayed, for example in the form of information signs, public transport signs, advertising posters, pricing labels, billboards etc. In addition, they may be used where a changing surface is required but not with detailed information content, such as wallpaper with a changing pattern or colour, especially if the surface requires a paper like appearance. The display may also be used as a light source.

The physical design of the pixels has not been described in detail, as this will be known to those skilled in the art. Further details of example of pixel design can be found in the references cited above and other standard references, and those mentioned above are incorporated herein by way of reference material.

Various modifications will be apparent to those skilled in the art.

1. A colour reflective display device, comprising a plurality of display pixels, wherein each pixel comprises two colour absorbing components (40,42), wherein the quantity of the two colour absorbing components within the pixel aperture can be independently controlled,
wherein the first colour absorbing component (C) has a colour at a point lying substantially between the green and blue regions of an (x,y) chromaticity diagram,
wherein the second colour absorbing component (O) has a colour at a point lying substantially between the green and red regions of an (x,y) chromaticity diagram.

2. A device as claimed in claim 1, wherein the line connecting the colour points (C,O) of the first and second absorbing components, in an (x,y) chromaticity diagram, substantially pass through the point (W) representing white.

3. A device as claimed in claim 1, wherein the first and second absorbing components (40,42), when combined, allow transmission of green light.

4. A device as claimed in claim 1, wherein the first and second absorbing components (40,42), when combined, allow transmission of grey light.

5. A device as claimed in claim 1, wherein the first and second absorbing components (40,42), when combined, allow transmission of purple or magenta light.

6. A device as claimed in claim 1, further comprising a coloured reflector (43).

7. A device as claimed in claim 6, wherein the coloured reflector (43) is purple or magenta.

8. A device as claimed in claim 7, wherein the first and second absorbing components (40,42), when combined, allow transmission of green light.

9. A device as claimed in claim 6, wherein the coloured reflector (43) is light green.

10. A device as claimed in claim 7, wherein the first and second absorbing components (40,42), when combined, allow transmission of purple or magenta light.

11. A device as claimed in claim 1, further comprising a white reflector.

12. A device as claimed in claim 11, wherein the first and second absorbing components (40,42), when combined, allow transmission of grey light.

13. A device as claimed in claim 6, wherein the reflector is the same colour for all pixels.

14. A device as claimed in claim 6, wherein the reflector comprises a first coloured area and a second white area.

15. A device as claimed in claim 1, comprising an in-plane switching electrophoretic display device.

16. A device as claimed in claim 15, wherein each pixel comprises particles suspended in a fluid, with a reservoir for housing the particles outside the pixel aperture.

17. A method of driving a display device, comprising moving coloured light absorbing particles into the optical aperture of each pixel to control the light absorbed and reflected by the pixel and thereby control the reflected colour output, wherein each pixel comprises two colour absorbing components (40,42), with the quantity of the two colour absorbing components within the pixel aperture being independently controlled, wherein the first colour absorbing component has a colour (C) at a point substantially along the line connecting the green and blue regions of an (x,y) chromaticity diagram, and wherein the second colour absorbing component has a colour (O) at a point substantially along the line connecting the green and red regions of an (x,y) chromaticity diagram.

18. A method as claimed in claim 17, further comprising converting a desired output colour and intensity into an output colour and intensity which can be produced as a pixel output.

19. A method as claimed in claim 18, wherein the conversion comprises shifting the desired output colour on an (x,y) chromaticity diagram onto a path (CO) between the points (C,O) of the first and second colour absorbing components which can be followed by selecting different quantities of the first and second colour absorbing components.

20. A method as claimed in claim 19, where the shifting comprises shifting the colour along a line (TQ) towards a predetermined point (Q) in the (x,y) chromaticity diagram until it reaches the path (CO).

21. A method as claimed in claim 20, wherein the point (Q) is in the vicinity of blue.

22. A method as claimed in claim 18, wherein the conversion comprises shifting the desired output colour into a volume (60) of an (x,y) chromaticity diagram.

23. A method as claimed in claim 22, wherein the volume (60) has a magenta side and a green side on each side of white, and wherein the conversion comprises clipping colours (T1,T2) outside the volume (60) until they reach the boundary (A1,A2) of the volume.

24. A method as claimed in claim 22, wherein the volume (60) has a magenta side and a green side, and wherein the conversion comprises scaling colours outside the volume (60) to within the volume.
